(19) United States
(12) Patent Application Publication
(10) Pub. No.: US 2006/0081526 A1
(43) Pub. Date: Apr. 20, 2006

(54) Oil filter casing with tool engaging member

(76) Inventor: Tony Gene Sanders, Kansas City, MO (US)

Correspondence Address: SHOOK, HARDY & BACON LLP;INTELLECTUAL PROPERTY DEPARTMENT, 2555 GRAND BLVD, KANSAS CITY,, MO, 64108-2613, US

(21) Appl. No.: 10/966,738

(22) Filed: Oct. 15, 2004

(51) Int. Cl. B01D 35/30

(52) U.S. Cl. 210/435; 210/445; 210/451

(57) ABSTRACT

An oil filter casing of the present invention includes a tool engaging member to facilitate oil filter installation and removal from mounting with an engine block. The oil filter casing includes a tubular sidewall spanning to a first end and a second enclosed end to house a filter element. The tool engaging member is connected with the enclosed end and is formed of a receiver extending inwardly towards the filter element and a brace extending from the receiver to connect with the casing at one or more locations distal to the receiver. The receiver is adapted to receiver a tool, such as a socket wrench, to effect rotation of the casing when rotatably mounted with an engine block.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

Oil filters for internal combustion engines are typically formed with a filter element housed within a tubular casing having a cylindrical shape. Such an oil filter has a threaded shaft or other threaded feature mating with a corresponding receiver on the engine block. This configuration enables the oil filter to be properly mounted for installation by simply screwing the oil filter onto the engine block. Similarly, removal of the oil filter is accomplished by rotating the oil filter in the opposite direction. The casing keeps the oil traveling through the filter from escaping the closed loop pathway within the engine block.

With respect to automobiles, farm implements, and other machinery employing an internal combustion engine, secure installation and later removal of an oil filter is often difficult due to the position of the filter relative to other components connected with and/or surrounding the engine block. For example, various hoses, structural members, and other electrical or mechanical components may at least partially block access to the mounting area of the oil filter. Installing an oil filter by hand tightening or through the use of other tools that “grip” the sidewall of the tubular casing may be possible in certain circumstances, but these methods lack effectiveness when the casing presents a low friction surface (e.g., when fluids or other debris are present on the casing) or when the is little room to access the oil filter from a side or lateral direction.

### BRIEF SUMMARY OF THE INVENTION

An oil filter casing is provided with an improved design for facilitating oil filter installation and removal from mounting with an engine block. The oil filter casing houses a filter element, and includes a tubular sidewall spanning to a first end and a second enclosed end opposing the first end. A tool engaging member is connected with the second end of the tubular casing and allows certain tools (e.g., socket wrench) to be interfaced with oil filter to effect rotation for mounting or dismounting of the oil filter. One component of the tool engaging member is a receiver extending inwardly from the second end of the tubular casing towards the filter element and formed of a set of interconnected wall portions. In this arrangement, the receiver presents a slot in the second end of the tubular casing configured to accept a tool, such as the ratchet end of a socket wrench. The receiver connects with a brace serving as another component of the tool engaging member. The brace spans across the set of interconnected wall portions and extends to rigidly connect with the tubular casing at one or more locations distal to the receiver. In this arrangement, the brace supports the receiver and thereby strengthens the tubular casing to reduce the risk of structural failure of the enclosed end of the casing due to high torque loads applied by tools within the receiver.

The oil filter casing design of the present invention employing a tool engaging member provides many advantages, including the ability to interface with a number of tools (e.g., socket wrench, allen wrench, etc.) for oil filter installation and removal while being structurally sound and relatively simple in design. In particular, through the use of socket wrench tools and extensions, the user may be spaced both axially and laterally from the oil filter and still be able to provide the torque necessary to fully mount or dismount the oil filter from an engine block. Other advantages will be become apparent from the description that follows.

### BRIEF DESCRIPTION OF THE SEVERAL VIEWS OF THE DRAWING

In the accompanying drawings which form a part of the specification and are to be read in conjunction therewith and in which like reference numerals are used to indicated like elements in the various views:

FIG. 1 is a perspective view of an oil filter casing in accordance with one embodiment of the present invention;

FIG. 2 is a front elevational view, taken partially in section, of the oil filter casing of FIG. 1 housing a filter element to form an oil filter assembly, and illustrating the configuration of the casing including a receiver and a brace;

FIG. 3 is a cross-sectional view of the oil filter assembly of FIG. 2 taken along line 3-3;

FIG. 4 is a fragmentary sectional view on an enlarged scale taken generally in the area identified by the numeral 4 in FIG. 2 illustrating one embodiment of the brace connected with the casing; and

FIG. 5 a fragmentary sectional view on an enlarged scale taken generally in the area identified by the numeral 4 in FIG. 2 illustrating another embodiment of the brace connected with the casing.

### DETAILED DESCRIPTION OF THE INVENTION

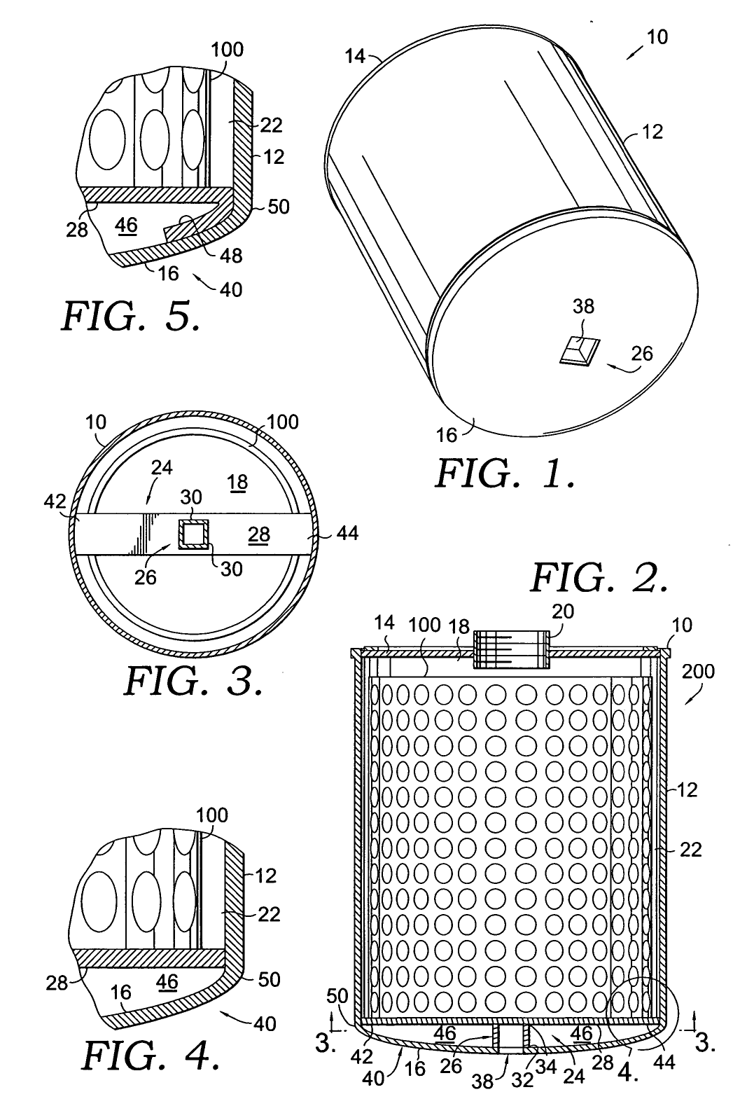

Turning now to the drawings, and initially to FIG. 1, there is illustrated an oil filter casing 10 of the present invention. The oil filter casing 10, or “casing” 10, is adapted to securely house therein a filter element 100, as can be seen in FIG. 2. The casing 10 and filter element 100 together form an oil filter assembly 200 that may be rotatably mounted onto the engine block of an internal combustion engine (not shown), and later removed, with the aid of various tools such as a socket wrench. The casing 10 has a tubular sidewall 12 that is generally cylindrical and spans to a first or mounting end 14 and to an opposing second or enclosed end 16 to define an interior region 18 therebetween. The configuration of the tubular sidewall 12 with the first and second ends 14, 16 is well known in the art and may be formed by traditional fabrication methods out of sheet metal or other similar materials. The filter element 100 may also be cylindrical such that the casing 10 and filter element 100 are concentric cylinders. A threaded shaft 20 extends from the filter element 100 at the mounting end 14 of the casing 10 and is received by a mating threaded receiver (not shown) on an engine block for securing the oil filter assembly 200 therewith. It should be understood that the filter element 100 and threaded shaft 18 shown are exemplary, and other arrangements for each may be implemented with the filter casing 10 of the present invention. For example, the filter element 100 and oil filter casing 10 may be connected together along the tubular sidewall 12 in the interior region 18 of the casing 10, or simply at the mounting end 14 such that a gap 22 exists between the sidewall 12 and the filter element 100.

To facilitate the use of a tool to effect rotation of the casing 10, and thus the oil filter assembly 200, a tool engaging member 24 is formed on the casing 10 as shown in FIGS. 1-3. The tool engaging member 24 includes a receiver 26 extending from the enclosed end 16 into the interior region 18 and a brace 28 extending outwardly or distally from the receiver 26 towards the sidewall 12 of the oil filter casing 10. The tool engaging member 24 may be formed from a variety of materials, as one example a metal suitable for rigid coupling with at least the enclosed end 16 of the casing 10.

The receiver 26 is formed of a set of set of interconnected wall portions 30 connected at lower edges 32 with the enclosed end 16 and at upper edges 34 with the brace 28. A hole is formed in the enclosed end 16 to create—along with the wall portions 30—a slot 38 for receiving a tool to effect oil filter casing 10 rotation. For instance, the receiver 26 may have four interconnected wall portions 30 as shown in FIGS. 2 and 3 to define a square slot 38 to receive a socket wrench. However, the receiver may be formed of various numbers of interconnected wall portions 30 to define slots of differing shapes for receiving tools therein to engage with and apply torque to the receiver 26. As another example, the slot 38 could be hexagonally shaped in cross-section. The receiver 26 preferably is located at a central longitudinal axis of the casing 10 extending from the mounting end 14 to the enclosed end 16.

The brace 28 may, in one embodiment, be a planar member, and covers the slot 38 to cut off the interior region 18 from the environment external to the casing 10 at the enclosed end 16. The brace extends laterally or transversely outwardly from the receiver 26 to connect with one or both of the enclosed end 16 and the tubular sidewall 12 of the casing 10. Preferably, the brace 28 extends a sufficient distance as to locate some portions of the brace 28 connected directly with the casing 10 closer to the sidewall 12 than to the receiver 26. Having some connection points between the brace 28 and the casing 10 distal to the receiver 26 reduces the concentration of stresses on the enclosed end 16 immediately surrounding the receiver 26 by directing torque loads applied by a tool to the receiver 26 to other regions of the casing 10 (e.g., towards a perimeter region 40 of the enclosed end 16 and/or to the sidewall 12.). In the embodiment shown in FIG. 4, for example, first and second ends 42, 44 of the brace 28 extend to and connect directly with the casing sidewall 12 at diametrically opposed positions. Because at least the enclosed end 16 of the casing 10 are often fabricated from thin sheet metal, having excessive concentrated stresses on the enclosed end 16 may result in failure of the material. By the design of the casing 10 of the present invention, the receiver 26 and brace 28 of the tool engaging member 24 reduce the risk of casing structural failure due to the application of torque loads necessary for oil filter removal.

The tool engaging member 24 may be rigidly secured to the tubular sidewall 12 and the enclosed end 16 by welding the lower edges 32 of the interconnected wall portions 30 over the hole in the enclosed end 16, and welding the first and second ends 42, 44 (or other portions) of the brace 28 to the desired location on the casing 10 (e.g., perimeter region 40 of the enclosed end 16 and/or to the sidewall 12). However, those of skill in the art will appreciate that other fabrication methods may be implemented to produce the casing 10 of the present invention.

The height of the interconnected wall portions 30 of the receiver 26 forming the slot 38 may be selected to allow sufficient surface area for tool engagement, and also to position the brace 28 to extend transversely outwardly to connection points on the casing 10 that are desired (e.g., perimeter region 40 of the enclosed end 16 and/or to the sidewall 12) without interfering with the space needed to house the filter element 100. For instance, the receiver 26 and brace 28 may be located within a portion of the interior region 18 that is usually wasted space; that is, the tool engaging member 24 may be located in an open region 46 between the filter element 100 and the enclosed end 16. The shape of the enclosed end 16 (e.g., in the embodiment illustrated in FIGS. 1 and 2, being parabolic) aids in positioning the tool engaging member 24 within the open region 46 while minimizing the amount of material necessary to form the tubular sidewall 12 and enclosed end 16 of the casing 10.

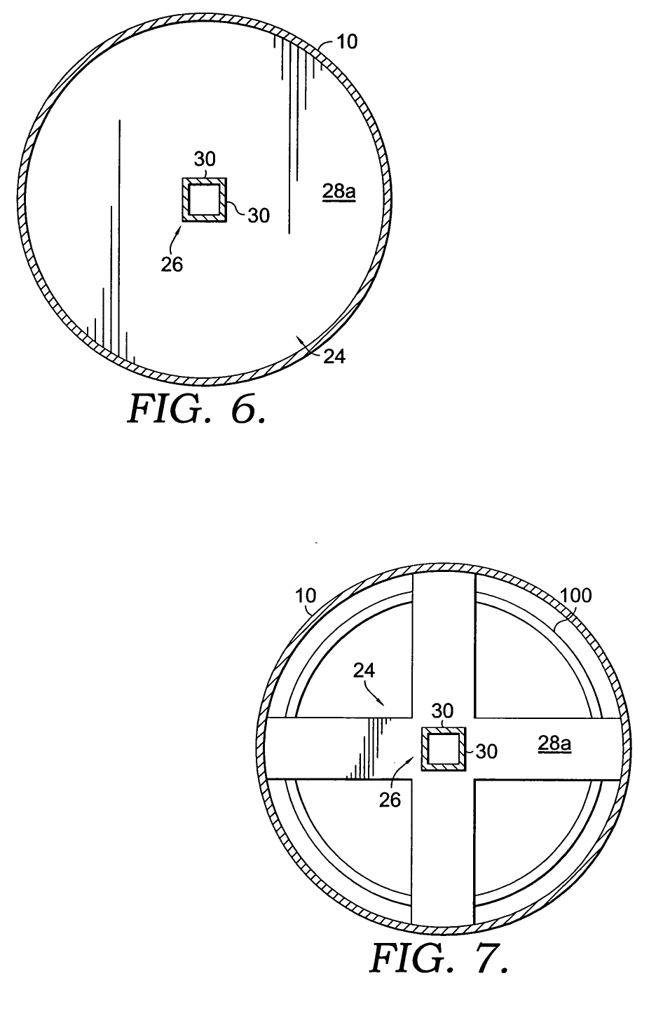

FIG. 5 shows another embodiment of the brace 28 having curved flanges 48 formed at the first and second brace ends 42, 44. The use of the curved flanges 48 positions connection points for the brace 28 directly at an annular corner 50 formed at the intersection of the tubular sidewall 12 and the enclosed end 16 of the casing 10. This arrangement provides additional support to the brace 28 upon the application of torque to the receiver 26 because the sidewall 12 and enclosed end 16 in effect “cradle” the brace 28 at or near the first and second brace ends 42, 44. Furthermore, the flanges 48 increase the surface area of connection between the brace 28 and the casing 10, thus reducing stresses at the connection points. It should be understood, however, that the curved flanges 48 could also take the form of flanges of other geometric shapes extending above or below more inwardly portions of the brace 28 and connecting with other portions of the perimeter region 40 of the enclosed end 16 and/or to the sidewall 12, to more efficiently spread out torque loads applied to the receiver 26 to other parts of the casing 10. As an example, a flange (not shown) could extend from the brace 28 into the gap between the filter element 100 and the sidewall 12 for connection with the sidewall. Moreover, the planar brace 28 shown in FIG. 4 could also be positioned to have first and second ends 42, 44 thereof connect directly with the annular corner 50.

Other embodiments of the brace 28 that may be implemented in the casing 10 of the present invention are shown in FIGS. 6 and 7. For instance, the brace 28 may extend radially from the receiver 26 as a plate member in the form of a disk 28a, as can be see in FIG. 6, and connect along the circumference thereof with the tubular sidewall 12 or with the enclosed end 16 near the sidewall 12. In another arrangement, the brace 28 shown in FIG. 7 takes the form of a cross 28b adding another member extension to the embodiment shown in FIG. 3. Those of skill in the art will appreciate that the embodiments of the brace 28 shown in the figures represent a sampling of the myriad of possible brace designs that are suitable for forming, along with the receiver 26, the tool engaging member 24.

The oil filter casing 10 of the present invention—by positioning of the tool engaging member 24 within the open region 46—provides a more compact design for a oil filter employing tool-assisted installation features. Unlike other designs that utilize an attachment affixed to the outside of an oil filter casing to engage with a tool, the tool engaging member 24 is located within the structure of the casing 10, and thus does not interfere with other structural members located around the engine block.

From the forgoing, it can be seen that the oil filter casing 10 of the present invention provides unobtrusive tool engaging features to facilitate ease of installation and removal of an oil filter. Since certain changes may be made in the above invention without departing from the scope hereof, it is intended that all matter contained in the above description or shown in the accompanying drawing be interpreted as illustrative and not in a limiting sense.

1. An oil filter assembly comprising:
a filter element; and
a tubular casing adapted to house the filter element and having a sidewall spanning to a first end, a second enclosed end, and a tool engaging member connected with the second enclosed end of the tubular casing, wherein the tool engaging member includes,
a receiver formed of a set of interconnected wall portions extending inwardly towards the filter element to present a slot in the second end, and
a brace spanning across and connected with the set of interconnected wall portions of the receiver and extending to connect with the tubular casing at one or more locations distal to the receiver;
wherein the receiver is adapted to receive a tool to effect rotation of the oil filter when rotatably mounted with an engine block about a central longitudinal axis of the tubular casing extending between the first and second ends thereof, and
wherein the brace spreads a torque load applied to the receiver by the tool out to the tubular casing at the one or more locations distal to the receiver.

2. The oil filter of claim 1, wherein the brace has a first end and a second end, the brace spanning across the set of interconnected wall portions of the receiver such that the first and second ends of the brace extend to connect with the tubular casing at generally diametrically opposed positions.

3. The oil filter of claim 2, wherein the first and second ends of the brace are proximal to the sidewall of the tubular casing.

4. The oil filter of claim 1, wherein the brace extends to connect with the sidewall of the tubular casing.

5. The oil filter of claim 1, wherein the brace has a planar section.

6. The oil filter of claim 5, wherein the brace has opposed first and second ends extending from the planar section, the first and second ends extending at least one of above and below the planar section and being connected with the tubular casing.

7. The oil filter of claim 1, wherein the tubular casing is cylindrical in shape and wherein the receiver is located at the central longitudinal axis of the tubular casing.

8. The oil filter of claim 1, wherein the receiver is shaped to accept a socket tool therein.

9. The oil filter of claim 1, wherein at least a portion of the brace extends to rigidly connect with the tubular casing at a location more proximal to the sidewall of the tubular casing than to the receiver.

10. The oil filter of claim 1, wherein the set of interconnected wall portions of the receiver have lower edges and upper edges, the lower edges connected with the second end of the tubular casing and the upper edges connected with the brace.

11. An oil filter assembly comprising:
a filter element;
a casing having an open end, a enclosed end, and a tubular sidewall extending therebetween defining an interior region adapted to house the filter element; and
means for engaging a tool to effect rotation of the oil filter when rotatably mounted with an engine block about a central longitudinal axis of the casing;
wherein the means for engaging a tool includes
a receiver formed of a set of interconnected wall portions extending from the enclosed end of the casing towards the interior region of the casing to present a slot in the enclosed end, and
a brace extending laterally from the receiver towards the tubular sidewall of the casing to connect with at least one of the enclosed end and the sidewall of the casing, the brace separating the slot in the enclosed end from the interior region of the casing.

12. The oil filter of claim 11, wherein the brace connects with the sidewall of the casing.

13. The oil filter of claim 11, wherein the brace connects with both of the enclosed ends and the sidewall of the casing.

14. The oil filter of claim 11, wherein the set of interconnected wall portions of the receiver extend in a direction parallel to a central longitudinal axis of the casing, and wherein the brace extends from the receiver in a direction orthogonal to the set of interconnected wall portions.

15. The oil filter of claim 11, wherein receiver is shaped to accept a socket tool therein.

16. The oil filter of claim 11, wherein the brace has a first end and a second end, the brace extending laterally from the receiver such that the first and second ends of the brace rigidly connect with the tubular casing at generally diametrically opposed positions.

17. The oil filter of claim 11, wherein the first and second ends of the brace rigidly connect with the sidewall of the tubular casing.

18. The oil filter of claim 11, wherein the set of interconnected wall portions of the receiver have lower edges and upper edges, the lower edges connected with the enclosed end of the casing and the upper edges connected with the brace.
